(19) United States
(12) Patent Application Publication
(10) Pub. No.: US 2013/0017081 A1
(43) Pub. Date: Jan. 17, 2013

(54) SYSTEM FOR ENHANCED RECOVERY OF TANGENTIAL ENERGY FROM AN AXIAL PUMP IN A LOOP REACTOR

(71) Applicant: Dale B. Andrews, Derry, NH (US)

(72) Inventor: Dale B. Andrews, Derry, NH (US)

(73) Assignee: Flowserve Management Company, Irving, TX (US)

(21) Appl. No.: 13/548,309

(22) Filed: Jul. 13, 2012

Related U.S. Application Data
(60) Provisional application No. 61/508,210, filed on Jul. 15, 2011.

(51) Int. Cl. F03B 11/02

(52) U.S. Cl. 415/208.1

(57) ABSTRACT

A loop reactor axial pump system improves conversion of tangential to axial flow of a flowing slurry by attaching a straight impeller section to the inlet of an elbow section. A pump shaft extends rotatably from the elbow through guide vanes located in the impeller section, so that flow from an impeller mounted on the shaft passes through the guide vanes before entering the elbow. When the impeller section is detached, the guide vanes have “see through” access from both ends, thereby allowing the guide vanes to be longer and/or more curved than in the prior art. Guide vanes can be straight or curved, and can have inlet angles approximating the absolute flow angle of the fluid, and/or outlet angles approximating 0 degrees. Additional guide vanes can be included in the elbow. Additional straight pipe sections containing only guide vanes can be included between the impeller section and the elbow.

### RELATED APPLICATIONS

This application claims the benefit of U.S. Provisional Application No. 61/508,210, filed Jul. 15, 2011, which is herein incorporated by reference in its entirety for all purposes.

### FIELD OF THE INVENTION

The invention relates to slurry polymerization in a liquid medium, and more particularly, to pumping apparatus for a loop reactor used for slurry polymerization.

### BACKGROUND OF THE INVENTION

Polyolefins such as polyethylene and polypropylene may be prepared by particle form polymerization, also referred to as slurry polymerization. With reference to FIG. 1, in this technique, feed materials such as monomer and catalyst are fed to a loop reactor 100, and a product slurry containing solid polyolefin particles in a liquid medium is taken off or withdrawn from the reactor 100.

With reference to FIG. 2, in a loop polymerization operation, a fluid slurry is circulated around the loop reactor 100 using one or more pumps 102, typically axial flow pumps having impellers 200 disposed within elbow sections 104 of the reactor 100 and drive shafts 202 extending through the walls of the elbow 104. As the volume of the reactor 100 and the solids concentration of the fluid slurry increase, the demands on the pump(s) also increase. In general, the flow rate, pressure, density, and viscosity of the fluid slurry must be considered in selecting and operating the loop reactor pump or pumps 102.

In addition to the concentration of the slurry, another factor affecting the solids concentration in the reactor is the fluid slurry circulation velocity. A higher slurry velocity for a given reactor diameter allows for a higher solids concentration, since the slurry velocity affects such limiting factors as heat transfer and reactor fouling due to polymer build up in the reactor.

Until fairly recently, fluid slurries of olefin polymers in a diluent were generally limited to relatively low concentrations of reactor solids. Settling legs were used to concentrate the slurry to be withdrawn, so that at the exit of the settling legs, the slurry would have a higher solids concentration. As the name implies, settling occurs in the setting legs to increase the solids concentration of the slurry to be withdrawn.

By increasing the head and flow capability of the loop reactor circulating pump(s), a higher weight-percent of solids can be circulated in the reactor. With reference to FIG. 2, axial flow pumps 102 propel a liquid by using an impeller 200 to accelerate the liquid both axially and tangentially. The total pressure head generated by an axial flow pump 102 operating at a given speed is dependent on the sum of the axial component, frictional losses, and the portion of the tangential energy that can be converted into velocity in the axial direction.

With reference to FIG. 3, axial pump systems in loop reactors 100 frequently employ guide vanes 300 or diffusers adjacent to the pump propeller 200 to assist in redirecting the tangential flow velocity exiting the propeller 200 into axial motion. Such guide vanes can be “pre-swirl” guide vanes 300 which impose a counter-tangential component onto the flow on the inlet side of the propeller 200, which is then cancelled by the propeller 200. Instead or in addition to pre-swirl guide vanes 300, outlet guide vanes 302 can be installed on the outlet side of the propeller 200.

FIG. 4 presents a view of inlet pre-swirl guide vanes 300 emerging from a pipe 400 which has been disconnected from the elbow 104 containing the propeller 200 of the axial pump 102.

For economy of manufacture, outlet guide vanes 302 typically only extend axially into a pipe or elbow 104 a distance that is accessible from one end of the elbow 104. This approach simplifies construction and reduces cost by allowing attachment of the vanes 302 within the elbow by conventional welding methods. Furthermore, upsets in polymerization systems sometimes cause the elbows 104 to become packed with hardened polymer. This requires that guide vanes 302 adjacent to the propeller 200 be short enough to allow a user to “see through” the guide vanes 302 despite their design curvature. This allows a rod or other tool to be inserted through the vanes 302 so as to clear out any polymer solids if necessary.

This “see through” requirement is illustrated in FIGS. 5, 6A, and 6B, which are cylindrical projections of a set of guide vanes 302 onto a flat surface. With reference to FIG. 5, if the vanes 300 are flat, then the ability to “see through” the vanes will depend only on their width, their spacing, and the angle they make with the axis of the pipe. If the vanes 302 were parallel to the pipe axis, they could have any width and spacing, but of course they would not be effective in converting tangential flow to axial flow.

FIG. 6A illustrates a cylindrical projection of a set of curved guide vanes 302 as seen from an angle, where the vanes 302 have widths, spacing, and average directions approximately equal to the flat vanes of FIG. 5. The vane curvature will allow the vanes 302 of FIG. 6A to be more effective in converting tangential flow to axial flow as compared to the vanes of FIG. 5, but at the same time the curvature of the vanes 302 increases their overlap. FIG. 6B illustrates a projection of the same set of curved vanes 302 as FIG. 6A, seen along the axis of the pipe. Clearly, the curvature of the vanes 302 causes then to overlap and prevents “see through,” even though all other properties of the vanes 300 are approximately equal to the flat vanes of FIG. 5.

It can be seen, therefore, that the “see through” requirement places a significant limit on the widths of the outlet guide vanes 302 located in the elbow 104. Although the short “see through” guide vanes 302 typically used in the art provide some conversion of tangential fluid velocity to axial velocity, and thereby increase the pump efficiency, a substantial tangential component of the fluid flow typically still remains as the fluid enters the bend in the elbow 104.

What is needed, therefore, is an improved design which will provide higher pump efficiency by recovering additional tangential fluid velocity generated by an axial pump in a loop reactor, while at the same time maintaining “see through” accessibility to and through all guide vanes for simplified welding during construction, maintenance between uses, and removal of clogged solids when necessary.

### SUMMARY OF THE INVENTION

An axial pumping system for a loop reactor includes an elbow section and a separate, straight impeller section. An outlet end of the impeller section is attachable to an inlet end of the elbow section. A guide vane assembly is fixed within the impeller section proximal to its outlet end. The elbow section is penetrated by a pump shaft which is coupled to a pump motor at a proximal end of the pump shaft, the pump motor being external to the elbow section. A distal end of the pump shaft extends through a portion of the elbow section, out through the inlet end of the elbow section, and into the impeller section through an opening in the guide vane assembly.

An impeller is attachable to the distal end of the pump shaft, so as to be located within the impeller section proximal to an inlet end of the impeller section. In embodiments, the length of the impeller section is less than twice the length of the guide vane assembly.

When the impeller is removed from the distal end of the pump shaft and the impeller section is removed from the elbow section, both ends of the guide vane assembly can be accessed through the open ends of the impeller section. This improved access (as compared to prior art designs in which the guide vanes are fixed within the elbow section) allows the guide vanes to be longer, more closely spaced, and/or to include greater curvature than prior art guide vane assemblies while maintaining “see-through” access.

In certain embodiments, if additional conversion of tangential to axial flow is desired, one or more secondary outlet guide vanes are also included within the elbow section proximal to the inlet end of the elbow section. In various embodiments, at least one straight guide-vane section containing one or more additional guide vanes can be included between the elbow section and the impeller section, whereby the pump shaft passes through an opening in the guide vanes of the guide-vane section. When the sections are disassembled, see-through access is available to the guide vanes in the guide-vane section from both of the open ends of the guide-vane section.

In some embodiments, at least some of the guide vanes of the present invention are straight and redirect the fluid by acting as a barrier that disrupts the tangential fluid motion. In other embodiments, at least some of the guide vanes are curved or otherwise shaped. Various embodiments include shaped guide vanes having inlet angles approximating the absolute flow angle of the fluid, which is the actual direction of fluid flow due to both its axial [meridianal] and tangential velocities. Certain embodiments include shaped guide vanes having outlet angles approximating 0 degrees relative to the meridianal axis of the elbow.

Conversion by the present invention of additional tangential flow into axial flow increases the net axial flow velocity. The additional pump head recovered will be proportional to the square of the net velocity increase. Thus, there will be an increase in useful work from the pump without a change in power consumption, yielding an increased efficiency.

Furthermore, quick recovery of the tangential fluid velocity into axial flow by the present invention decreases the friction of polymer particles on the reactor loop and pump sidewalls, thereby reducing the amount of polymer decay and increasing the percentage of useable and saleable product obtained from the reactor.

One general aspect of the present invention is an axial pumping system for a loop reactor that includes a curved elbow pipe section, a pump shaft penetrating a curved portion of the elbow pipe section, a distal end of the pump shaft extending through and beyond an inlet end of the elbow pipe section, a pump motor located external to the elbow pipe section and coupled to a proximal end of the pump shaft, a substantially straight impeller pipe section having an outlet end which is concentrically attachable to the inlet end of the elbow pipe section, so that the distal end of the pump shaft extends into the impeller pipe section, a pump impeller mountable on the distal end of the pump shaft when the impeller pipe section is attached to the elbow pipe section, the impeller being thereby positioned in an inlet region of the impeller pipe section, and a guide vane assembly located in an outlet region of the impeller pipe section.

The guide vane assembly includes a passage through which the pump shaft rotatably extends when the outlet end of the impeller pipe section is attached to the inlet end of the elbow pipe section. The guide vane section further includes see-through access from both the inlet and outlet ends of the impeller pipe section when the impeller is detached from the distal end of the pump shaft and the impeller pipe section is detached from the elbow pipe section. The guide vane section also is configured so as to convert tangential flow created by rotation of the impeller into axial flow.

In embodiments, the guide vane assembly includes at least one guide vane that is straight.

In some embodiments, the guide vane assembly includes at least one guide vane that is curved. In some of these embodiments the at least one guide vane has an inlet angle which is approximately equal to an absolute flow angle of fluid propelled to the at least one guide vane by the impeller. In other of these embodiments the at least one guide vane has an outlet angle that is approximately parallel to the axis of the impeller pipe section.

In various embodiments a length of the impeller pipe section is less than two times a length of the guide vane assembly.

Certain embodiments further include an elbow guide vane assembly located in an inlet region of the elbow pipe section, the elbow guide vane assembly being configured so as to convert tangential flow created by rotation of the impeller into axial flow.

Some embodiments further include a substantially straight guide-vane pipe section, the guide-vane pipe section having an outlet end that is attachable to the inlet end of the elbow pipe section and an inlet end that is attachable to the outlet end of the impeller pipe section, the guide-vane pipe section including a secondary guide vane assembly installed therein, the secondary guide vane assembly including a passage through which the distal end of the pump shaft rotatably extends when the outlet end of the guide-vane pipe section is attached to the inlet end of the elbow pipe section, the secondary guide vane assembly being configured so as to convert tangential flow created by rotation of the impeller into axial flow.

In some of these embodiments a length of the guide-vane pipe section is not more than 20% longer than a length of the secondary guide vane assembly.

Another general aspect of the present invention is a loop reactor polymerization system that includes a loop reactor including a plurality of straight sections interconnected by a plurality of elbow sections so as to form a closed loop of tubing, a pump shaft having a distal end penetrating a curved portion of one of the elbow pipe sections, referred to herein as the pumping elbow, and extending beyond an inlet end of the pumping elbow, a pump motor located external to the closed loop of tubing and coupled to a proximal end of the pump shaft, a substantially straight impeller pipe section having an outlet end concentrically coupled to the inlet end of the elbow pipe section, so that the distal end of the pump shaft extends into the impeller pipe section, a pump impeller mounted on the distal end of the pump shaft and positioned in an inlet region of the impeller pipe section, and a guide vane assembly located in an outlet region of the impeller pipe section between the impeller and the elbow pipe section.

The guide vane assembly includes a passage through which the pump shaft rotatably extends, the guide vane assembly has see-through access from the inlet and outlet ends of the impeller pipe section when the impeller is detached from the distal end of the pump shaft and the both ends of the impeller pipe section are detached from the loop reactor, and the guide vane assembly is configured so as to convert tangential flow created by rotation of the impeller into axial flow.

In embodiments, the guide vane assembly includes at least one guide vane that is straight.

In some embodiments the guide vane assembly includes at least one guide vane that is curved. In some of these embodiments the at least one guide vane has an inlet angle which is approximately equal to an absolute flow angle of fluid propelled to the secondary guide vane by the impeller. In other of these embodiments the at least one guide vane has an outlet angle that is approximately parallel to the axis of the impeller pipe section.

In various embodiments a length of the impeller pipe section is less than two times a length of the guide vane assembly. Certain embodiments further include an elbow guide vane assembly located in an inlet region of the elbow pipe section, the elbow guide vane assembly being configured so as to convert tangential flow created by rotation of the impeller into axial flow.

Some embodiments further include a substantially straight guide vane pipe section, the guide vane pipe section having an outlet end that is attachable to the inlet end of the elbow pipe section and an inlet end that is attachable to the outlet end of the impeller pipe section, the guide vane pipe section including a secondary guide vane assembly installed therein, the secondary guide vane assembly including a passage through which the distal end of the pump shaft rotatably extends when the outlet end of the guide vane pipe section is attached to the inlet end of the elbow pipe section, the secondary guide vane assembly being configured so as to convert tangential flow created by rotation of the impeller into axial flow.

In some of these embodiments a length of the guide vane pipe section is not more than 20% longer than a length of the secondary guide vane assembly.

And certain embodiments further include a plurality of pump shafts penetrating a plurality of elbow sections coupled to a plurality of corresponding impeller pipe sections, the pump shafts passing rotatably through guide vane assemblies in outlet regions of the impeller pipe sections and having impellers attached to their distal ends within inlet regions of the impeller pipe sections, the guide vane assemblies being configured so as to convert tangential flow created by rotation of the impellers into axial flow.

One general aspect of the present invention is an axial pumping system for a loop reactor, which includes a curved elbow pipe section, a pump shaft penetrating a curved portion of the elbow pipe section, a distal end of the pump shaft extending through and beyond an inlet end of the elbow pipe section, a pump motor located external to the elbow pipe section and coupled to a proximal end of the pump shaft, a substantially straight impeller pipe section having an outlet end which is concentrically attachable to the inlet end of the elbow pipe section, so that the distal end of the pump shaft extends into the impeller pipe section, a pump impeller mountable on the distal end of the pump shaft when the impeller pipe section is attached to the elbow pipe section, the impeller being thereby positioned in an inlet region of the impeller pipe section, and a guide vane assembly located in an outlet region of the impeller pipe section.

The guide vane assembly includes a passage through which the pump shaft rotatably extends when the outlet end of the impeller pipe section is attached to the inlet end of the elbow pipe section. The guide vane assembly also has see-through access from both the inlet and outlet ends of the impeller pipe section when the impeller is detached from the distal end of the pump shaft and the impeller pipe section is detached from the elbow pipe section. And the guide vane assembly is configured so as to convert tangential flow created by rotation of the impeller into axial flow.

In embodiments, the guide vane assembly includes at least one guide vane that is straight.

In other embodiments, the guide vane assembly includes at least one guide vane that is curved. In some of these embodiments the at least one guide vane has an inlet angle which is approximately equal to an absolute flow angle of fluid propelled to the at least one guide vane by the impeller. In other of these embodiments the at least one guide vane has an outlet angle that is approximately parallel to the axis of the impeller pipe section.

In various embodiments, a length of the impeller pipe section is less than two times a length of the guide vane assembly. And certain embodiments further include an elbow guide vane assembly located in an inlet region of the elbow pipe section, the elbow guide vane assembly being configured so as to convert tangential flow created by rotation of the impeller into axial flow.

Embodiments further include a substantially straight guide-vane pipe section, the guide-vane pipe section having an outlet end that is attachable to the inlet end of the elbow pipe section and an inlet end that is attachable to the outlet end of the impeller pipe section, the guide-vane pipe section including a secondary guide vane assembly installed therein, the secondary guide vane assembly including a passage through which the distal end of the pump shaft rotatably extends when the outlet end of the guide-vane pipe section is attached to the inlet end of the elbow pipe section, and the secondary guide vane assembly being configured so as to convert tangential flow created by rotation of the impeller into axial flow. In some of these embodiments a length of the guide-vane pipe section is not more than 20% longer than a length of the secondary guide vane assembly.

Another general aspect of the present invention is a loop reactor polymerization system that includes a loop reactor including a plurality of straight sections interconnected by a plurality of elbow sections so as to form a closed loop of tubing, a pump shaft having a distal end penetrating a curved portion of one of the elbow pipe sections, referred to herein as the pumping elbow, and extending beyond an inlet end of the pumping elbow, a pump motor located external to the closed loop of tubing and coupled to a proximal end of the pump shaft, a substantially straight impeller pipe section having an outlet end concentrically coupled to the inlet end of the elbow pipe section, so that the distal end of the pump shaft extends into the impeller pipe section, a pump impeller mounted on the distal end of the pump shaft and positioned in an inlet region of the impeller pipe section, and a guide vane assembly located in an outlet region of the impeller pipe section between the impeller and the elbow pipe section.

The guide vane assembly includes a passage through which the pump shaft rotatably extends. The guide vane assembly hays see-through access from the inlet and outlet ends of the impeller pipe section when the impeller is detached from the distal end of the pump shaft and the both ends of the impeller pipe section are detached from the loop reactor. And the guide vane assembly is configured so as to convert tangential flow created by rotation of the impeller into axial flow.

In embodiments, the guide vane assembly includes at least one guide vane that is straight.

In certain embodiments, the guide vane assembly includes at least one guide vane that is curved. In some of these embodiments the at least one guide vane has an inlet angle which is approximately equal to an absolute flow angle of fluid propelled to the secondary guide vane by the impeller. In other of these embodiments the at least one guide vane has an outlet angle that is approximately parallel to the axis of the impeller pipe section.

In various embodiments a length of the impeller pipe section is less than two times a length of the guide vane assembly.

Some embodiments further include an elbow guide vane assembly located in an inlet region of the elbow pipe section, the elbow guide vane assembly being configured so as to convert tangential flow created by rotation of the impeller into axial flow.

Embodiments further include a substantially straight guide vane pipe section, the guide vane pipe section having an outlet end that is attachable to the inlet end of the elbow pipe section and an inlet end that is attachable to the outlet end of the impeller pipe section, the guide vane pipe section including a secondary guide vane assembly installed therein, the secondary guide vane assembly including a passage through which the distal end of the pump shaft rotatably extends when the outlet end of the guide vane pipe section is attached to the inlet end of the elbow pipe section, and the secondary guide vane assembly being configured so as to convert tangential flow created by rotation of the impeller into axial flow. In some of these embodiments a length of the guide vane pipe section is not more than 20% longer than a length of the secondary guide vane assembly.

And certain embodiments further include a plurality of pump shafts penetrating a plurality of elbow sections coupled to a plurality of corresponding impeller pipe sections, the pump shafts passing rotatably through guide vane assemblies in outlet regions of the impeller pipe sections and having impellers attached to their distal ends within inlet regions of the impeller pipe sections, the guide vane assemblies being configured so as to convert tangential flow created by rotation of the impellers into axial flow.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is perspective view of a loop reactor system of the prior art;

FIG. 2 is cut-away side view of an axial pump installed in an elbow section of a loop reactor of the prior art;

FIG. 3 is a cross sectional side view of a prior art configuration similar to FIG. 2, but including both pre-swirl and outlet guide vanes;

FIG. 4 is a perspective view of a set of prior art pre-swirl guide vanes installed in a pipe section which has been disconnected from the elbow of FIG. 3;

FIG. 5 is a cylindrical projection of a set of straight secondary guide vanes viewed from the side in an embodiment of the present invention;

FIG. 6A is a cylindrical projection of a set of curved secondary guide vanes viewed from an angle in an embodiment of the present invention;

FIG. 6B is an illustration of the cylindrical projection of FIG. 6A viewed from the side;

FIG. 7 is a cross sectional view of an embodiment of the present invention;

FIG. 8A is an exploded perspective view drawn to scale of an embodiment similar to FIG. 7;

FIG. 8B is a front view drawn to scale of the impeller section of the embodiment of FIG. 8A; and

FIG. 9 is a cross sectional view of an embodiment similar to FIG. 7, but including a guide vane section installed between the elbow section and the impeller section.

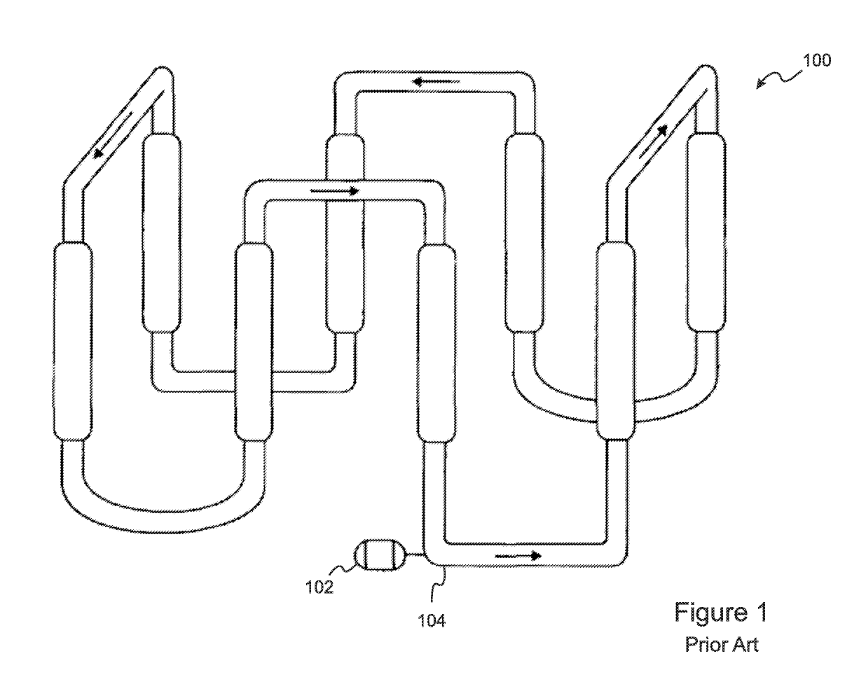

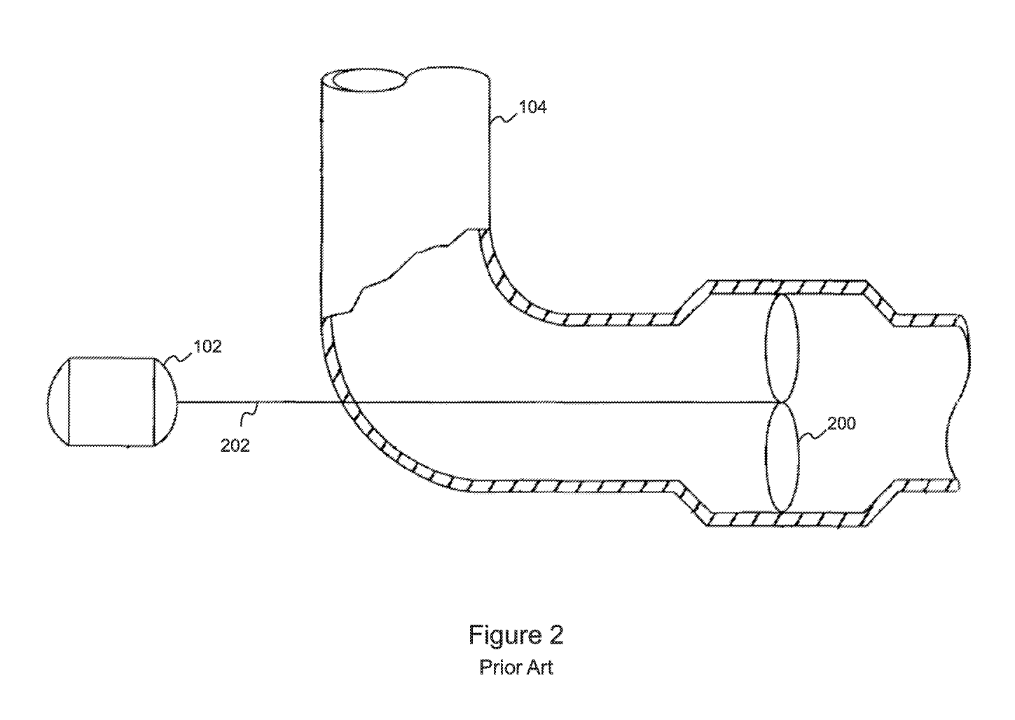

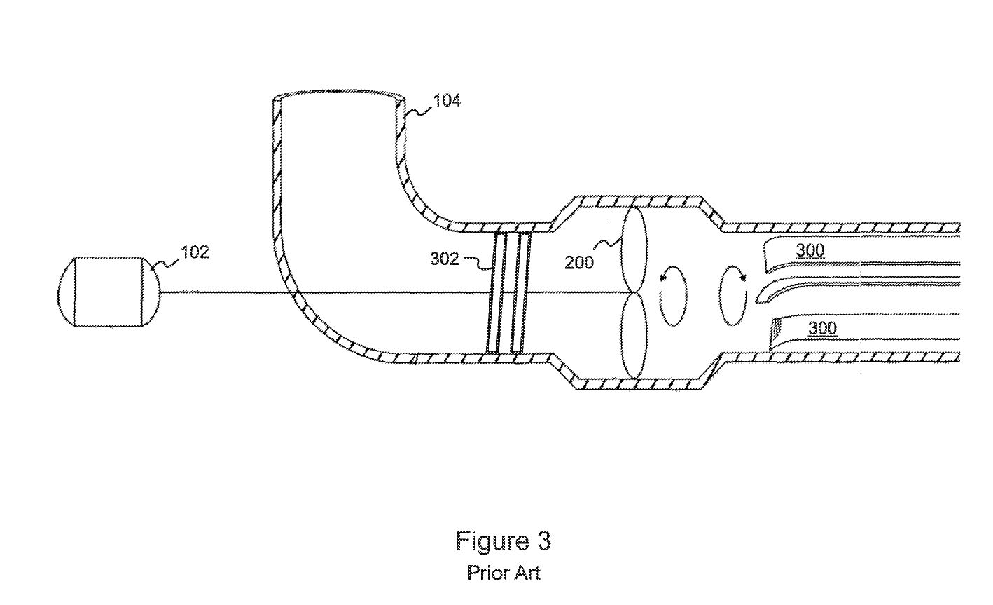

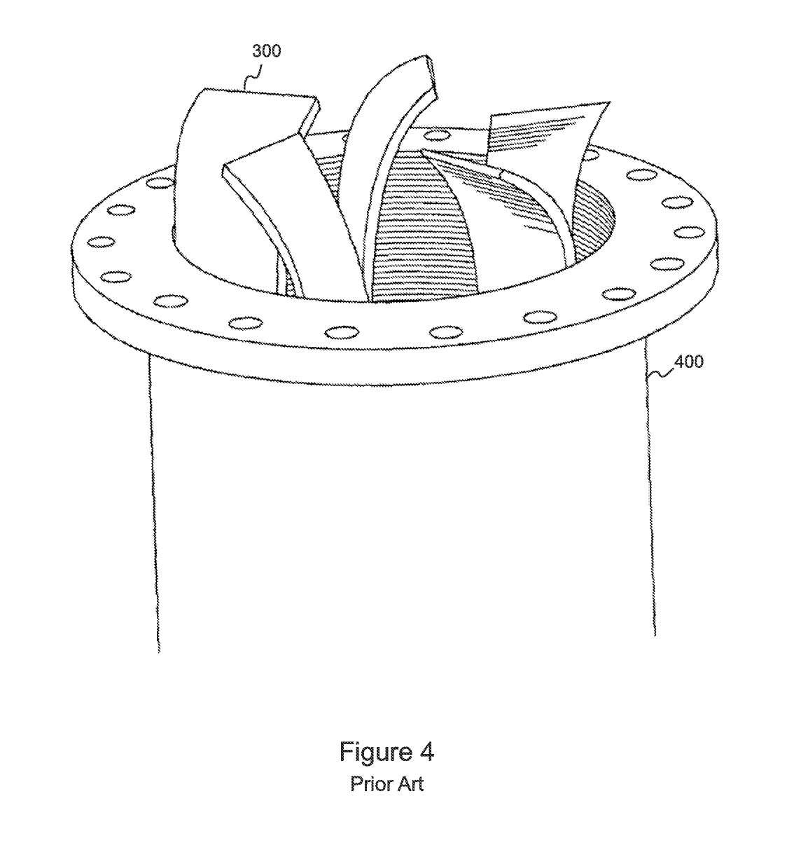

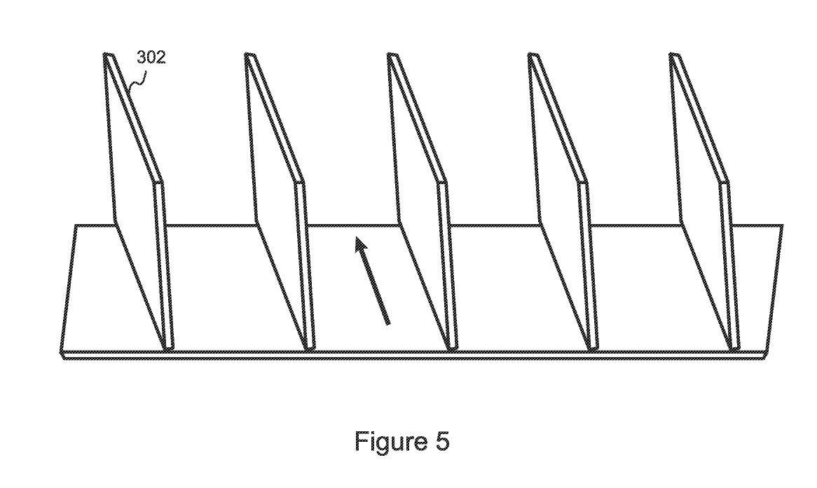

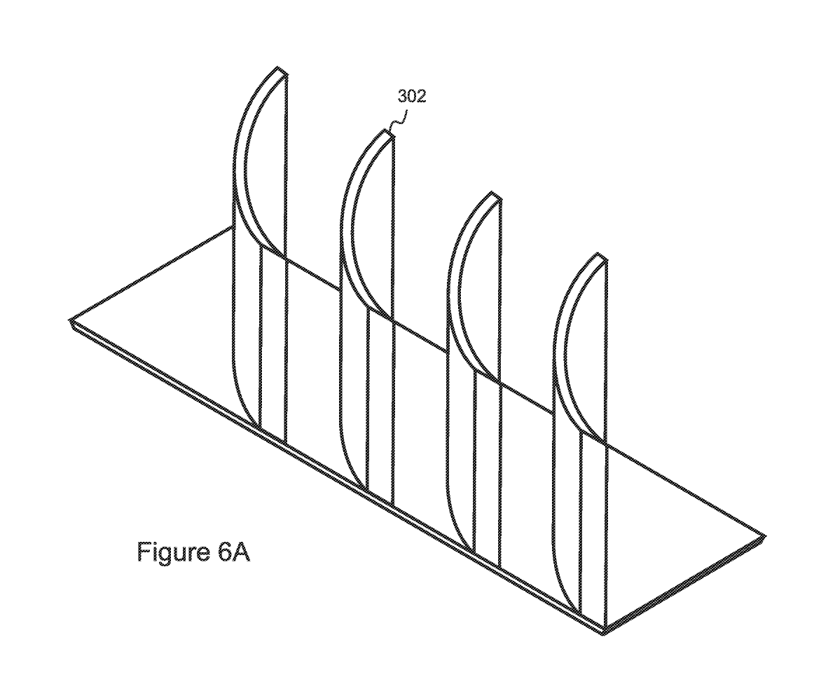

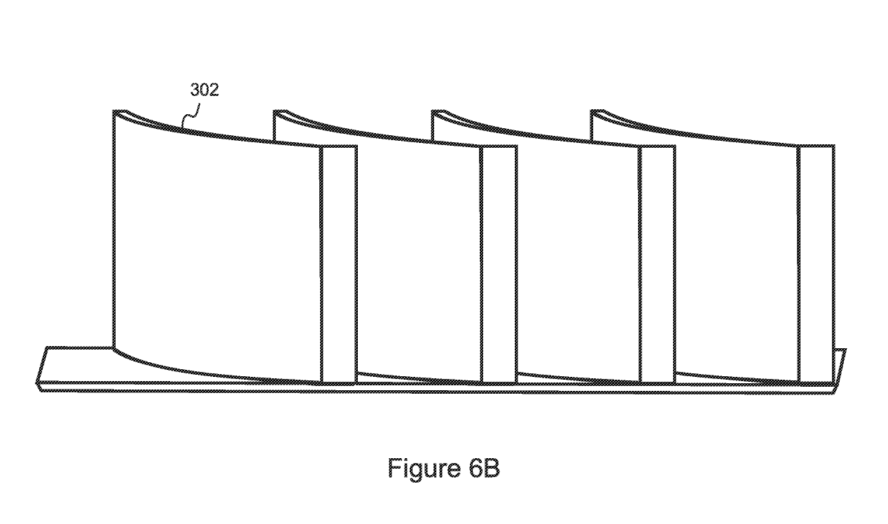

### DETAILED DESCRIPTION

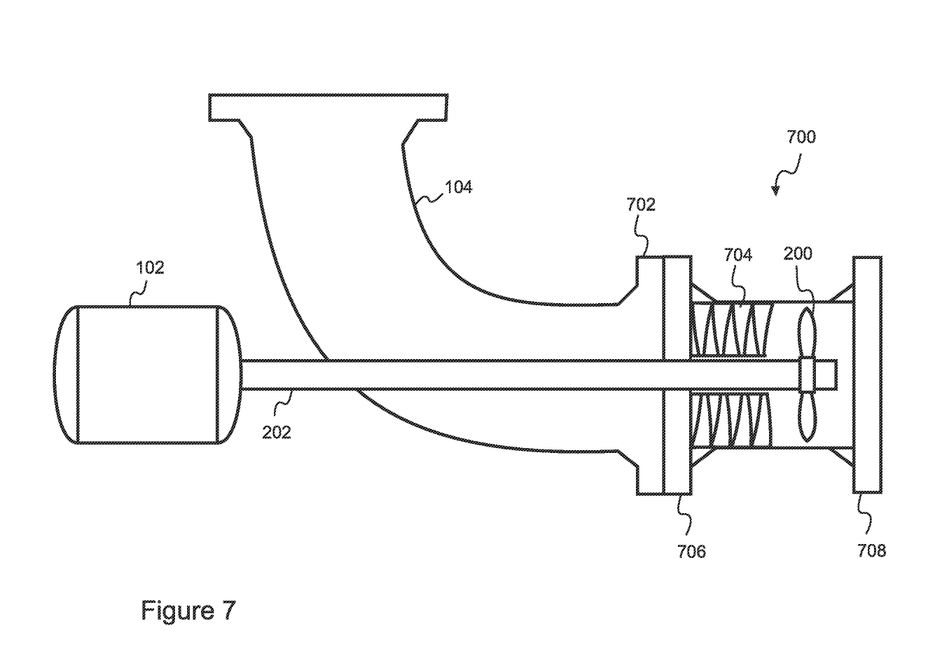

With reference to FIG. 7, an axial pumping system for a loop reactor includes an elbow section 104 and a separate, straight impeller section 700. An outlet end 706 of the impeller section 700 is attachable to an inlet end 702 of the elbow section. A guide vane assembly 704 is fixed within the impeller section 700 proximal to its outlet end 706. The elbow section 104 is penetrated by a pump shaft 202 which is coupled to a pump motor 102 at a proximal end of the pump shaft 202, the pump motor 102 being external to the elbow section 104. A distal end of the pump shaft 202 extends through a portion of the elbow section 104, out through the inlet end 702 of the elbow section 104, and into the impeller section 700 through an opening in the guide vane assembly 704.

An impeller 200 is attachable to the distal end of the pump shaft 202, so as to be located within the impeller section 700 proximal to an inlet end 708 of the impeller section 700. In the embodiment of FIG. 7, the length of the impeller section 700 is less than twice the length of the guide vane assembly 704.

When the impeller 200 is removed from the distal end of the pump shaft 202 and the impeller section 700 is removed from the elbow section 104, both ends of the guide vane assembly 704 can be accessed through the open ends 706, 708 of the impeller section 700. This improved access (as compared to prior art designs in which the guide vanes are fixed within the elbow section) allows the guide vanes 704 to be longer, more closely spaced, and/or to include greater curvature than prior art guide vane assemblies while maintaining “see-through” access, thereby allowing the guide vanes 704 to convert more tangential flow into axial flow than prior art designs. The improved access also allows the longer and/or more curved guide vane assembly 704 to be welded by conventional methods known in the art into the outlet end of the impeller section 700 during manufacture.

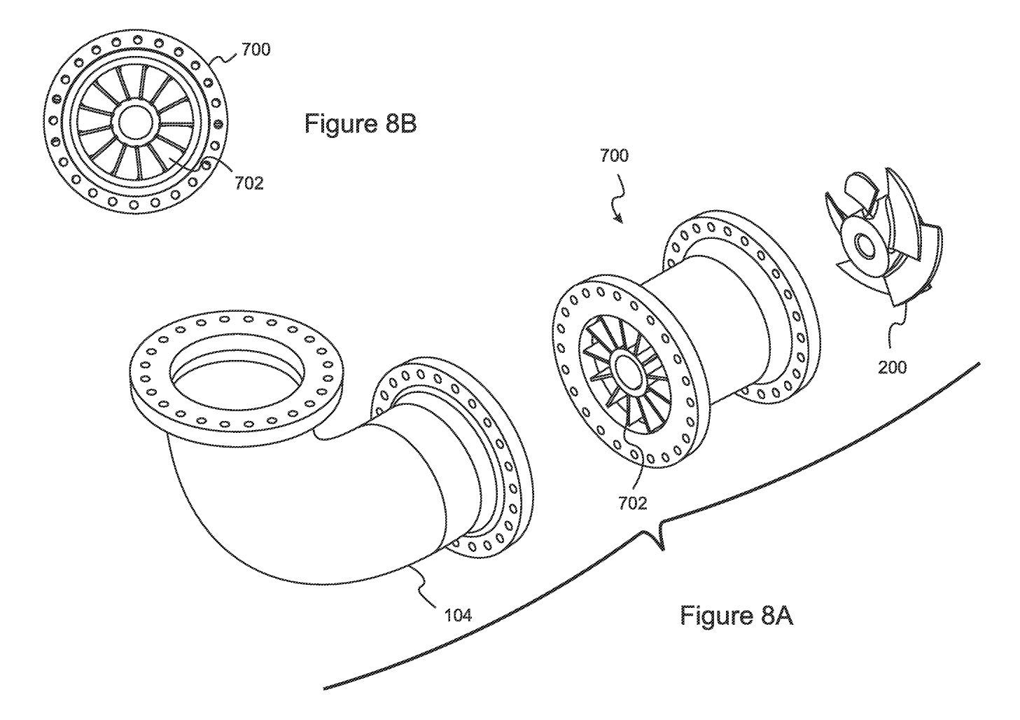

FIG. 8A is an exploded perspective view drawn to scale of an embodiment similar to FIG. 7. The pump 102 and pump shaft 202 have been omitted from the figure for clarity of illustration. FIG. 8B is a front view drawn to scale of the impeller section 702 of FIG. 8A.

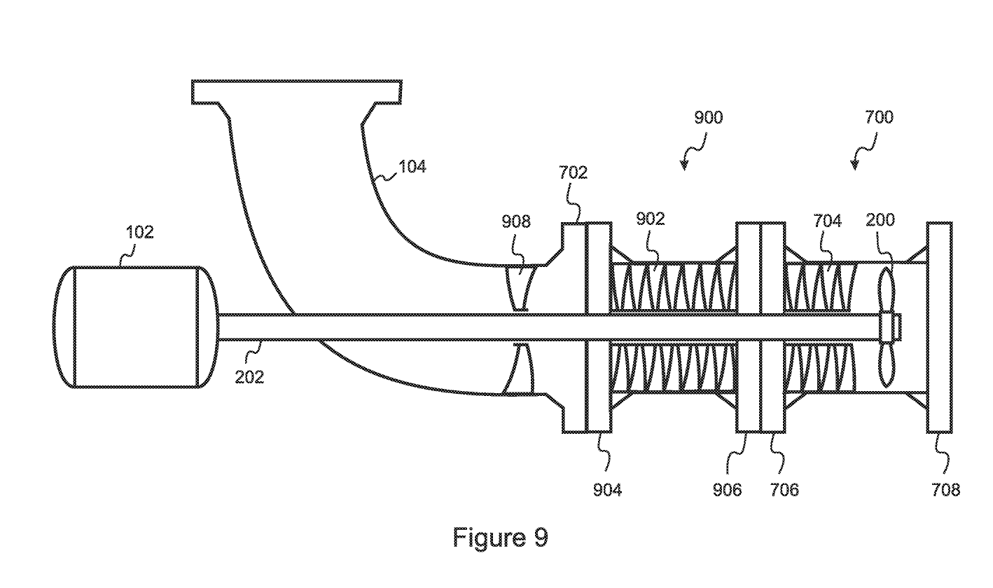

With reference to FIG. 9, in various embodiments if additional conversion of tangential flow to axial flow is desired, one or more secondary outlet guide vanes 908 can be included within the elbow section 104 proximal to the inlet end 702 of the elbow section 104.

Also with reference to FIG. 9, in some embodiments at least one straight guide-vane section 900 is included between the elbow section 104 and the impeller section 700. At least one additional guide vane 902 is included within the guide-vane section 900, whereby the pump shaft 202 passes through an opening in the at least one guide vane 902 in the guide-vane section 900. When the sections 104, 700, 900 are disassembled, see-through access is available to the at least one guide vane 902 in the guide-vane section 900 from the open ends 904, 906 of the guide vane section 900.

In some embodiments, at least some of the guide vanes of the present invention are straight and redirect the fluid by acting as a barrier that disrupts the tangential fluid motion. In other embodiments, at least some of the guide vanes are curved or otherwise shaped. Various embodiments include shaped guide vanes having inlet angles approximating the absolute flow angle of the fluid, which is the actual direction of fluid flow due to both its axial [meridianal] and tangential velocities. Certain embodiments include shaped guide vanes having outlet angles approximating 0 degrees relative to the meridianal axis of the elbow.

Conversion by the present invention of additional tangential flow into axial flow increases the net axial flow velocity. The additional pump head recovered will be proportional to the square of the net velocity increase. Thus, there will be an increase in useful work from the pump without a change in power consumption, yielding an increased efficiency.

Furthermore, quick recovery of the tangential fluid velocity into axial flow by the present invention decreases the friction of polymer particles on the reactor loop and pump sidewalls, thereby reducing the amount of polymer decay and increasing the percentage of useable and saleable product obtained from the reactor.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An axial pumping system for a loop reactor, comprising:
a curved elbow pipe section;
a pump shaft penetrating a curved portion of the elbow pipe section, a distal end of the pump shaft extending through and beyond an inlet end of the elbow pipe section;
a pump motor located external to the elbow pipe section and coupled to a proximal end of the pump shaft;
a substantially straight impeller pipe section having an outlet end which is concentrically attachable to the inlet end of the elbow pipe section, so that the distal end of the pump shaft extends into the impeller pipe section;
a pump impeller mountable on the distal end of the pump shaft when the impeller pipe section is attached to the elbow pipe section, the impeller being thereby positioned in an inlet region of the impeller pipe section; and
a guide vane assembly located in an outlet region of the impeller pipe section,
the guide vane assembly including a passage through which the pump shaft rotatably extends when the outlet end of the impeller pipe section is attached to the inlet end of the elbow pipe section,
the guide vane assembly having see-through access from both the inlet and outlet ends of the impeller pipe section when the impeller is detached from the distal end of the pump shaft and the impeller pipe section is detached from the elbow pipe section, and
the guide vane assembly being configured so as to convert tangential flow created by rotation of the impeller into axial flow.

2. The system of claim 1, wherein the guide vane assembly includes at least one guide vane that is straight.

3. The system of claim 1, wherein the guide vane assembly includes at least one guide vane that is curved.

4. The system of claim 3, wherein the at least one guide vane has an inlet angle which is approximately equal to an absolute flow angle of fluid propelled to the at least one guide vane by the impeller.

5. The system of claim 3, wherein the at least one guide vane has an outlet angle that is approximately parallel to the axis of the impeller pipe section.

6. The system of claim 1, wherein a length of the impeller pipe section is less than two times a length of the guide vane assembly.

7. The system of claim 1, further comprising an elbow guide vane assembly located in an inlet region of the elbow pipe section, the elbow guide vane assembly being configured so as to convert tangential flow created by rotation of the impeller into axial flow.

8. The system of claim 1, further comprising a substantially straight guide-vane pipe section,
the guide-vane pipe section having an outlet end that is attachable to the inlet end of the elbow pipe section and an inlet end that is attachable to the outlet end of the impeller pipe section,
the guide-vane pipe section including a secondary guide vane assembly installed therein, the secondary guide vane assembly including a passage through which the distal end of the pump shaft rotatably extends when the outlet end of the guide-vane pipe section is attached to the inlet end of the elbow pipe section, and
the secondary guide vane assembly being configured so as to convert tangential flow created by rotation of the impeller into axial flow.

9. The system of claim 8, wherein a length of the guide-vane pipe section is not more than 20% longer than a length of the secondary guide vane assembly.

10. A loop reactor polymerization system comprising:
a loop reactor including a plurality of straight sections interconnected by a plurality of elbow sections so as to form a closed loop of tubing;
a pump shaft having a distal end penetrating a curved portion of one of the elbow pipe sections, referred to herein as the pumping elbow, and extending beyond an inlet end of the pumping elbow;
a pump motor located external to the closed loop of tubing and coupled to a proximal end of the pump shaft;
a substantially straight impeller pipe section having an outlet end concentrically coupled to the inlet end of the elbow pipe section, so that the distal end of the pump shaft extends into the impeller pipe section;
a pump impeller mounted on the distal end of the pump shaft and positioned in an inlet region of the impeller pipe section; and
a guide vane assembly located in an outlet region of the impeller pipe section between the impeller and the elbow pipe section,
the guide vane assembly including a passage through which the pump shaft rotatably extends,
the guide vane assembly having see-through access from the inlet and outlet ends of the impeller pipe section when the impeller is detached from the distal end of the pump shaft and the both ends of the impeller pipe section are detached from the loop reactor, and
the guide vane assembly being configured so as to convert tangential flow created by rotation of the impeller into axial flow.

11. The system of claim 10 wherein the guide vane assembly includes at least one guide vane that is straight.

12. The system of claim 10, in which the guide vane assembly includes at least one guide vane that is curved.

13. The system of claim 12, wherein the at least one guide vane has an inlet angle which is approximately equal to an absolute flow angle of fluid propelled to the secondary guide vane by the impeller.

14. The system of claim 12, wherein the at least one guide vane has an outlet angle that is approximately parallel to the axis of the impeller pipe section.

15. The system of claim 10, wherein a length of the impeller pipe section is less than two times a length of the guide vane assembly.

16. The system of claim 10, further comprising an elbow guide vane assembly located in an inlet region of the elbow pipe section, the elbow guide vane assembly being configured so as to convert tangential flow created by rotation of the impeller into axial flow.

17. The system of claim 10, further comprising a substantially straight guide vane pipe section,
the guide vane pipe section having an outlet end that is attachable to the inlet end of the elbow pipe section and an inlet end that is attachable to the outlet end of the impeller pipe section,
the guide vane pipe section including a secondary guide vane assembly installed therein, the secondary guide vane assembly including a passage through which the distal end of the pump shaft rotatably extends when the outlet end of the guide vane pipe section is attached to the inlet end of the elbow pipe section, and
the secondary guide vane assembly being configured so as to convert tangential flow created by rotation of the impeller into axial flow.

18. The system of claim 17, wherein a length of the guide vane pipe section is not more than 20% longer than a length of the secondary guide vane assembly.

19. The system of claim 10, further comprising a plurality of pump shafts penetrating a plurality of elbow sections coupled to a plurality of corresponding impeller pipe sections, the pump shafts passing rotatably through guide vane assemblies in outlet regions of the impeller pipe sections and having impellers attached to their distal ends within inlet regions of the impeller pipe sections, the guide vane assemblies being configured so as to convert tangential flow created by rotation of the impellers into axial flow.
